(19) United States
(12) Patent Application Publication
(10) Pub. No.: US 2024/0168761 A1
(43) Pub. Date: May 23, 2024

(54) CONTENT-AWARE AUTO-SCALING OF STREAM PROCESSING APPLICATIONS ON CONTAINER ORCHESTRATION

(71) Applicant: NEC Laboratories America, Inc., Princeton, NJ (US)

(72) Inventors: Giuseppe Coviello, Robbinsville, NJ (US); Kunal Rao, Monroe, NJ (US); Srimat Chakradhar, Manalapan, NJ (US); Ciro Giuseppe DeVita, Napoli (IT); Gennaro Mellone, Princeton, NJ (US); Priscilla Benedetti, Perugia (IT)

(21) Appl. No.: 18/515,889

(22) Filed: Nov. 21, 2023

Related U.S. Application Data
(60) Provisional application No. 63/427,152, filed on Nov. 22, 2022.

(51) Int. Cl. G06F 9/22; G06F 9/38

(52) U.S. Cl. CPC G06F 9/226; G06F 9/3867

(57) ABSTRACT

Systems and methods for scaling in a container orchestration platform are described that include configuring an autoscaler in a control plane of the container orchestration platform to receive stream data from a data exchange system that is measuring stream processing of a pipeline of microservices for an application. The systems and methods further include controlling a number of deployment pods in at least one node of the container orchestration platform to meet requirements for the application provided by the pipeline of microservices.

### RELATED APPLICATION INFORMATION

This application claims priority to U.S. 63/427,152 filed on Nov. 22, 2022 incorporated herein by reference in its entirety.

### BACKGROUND

### Technical Field

The present invention relates to container management for distributed

computing, such as cloud computing environments. More particularly, the present invention relates to scaling on Kubernetes.

### Description of the Related Art

Kubernetes is a platform for deploying and managing containerized applications. When applications are packaged as containers, the software dependencies can be embedded within the container. This makes it portable to run, e.g., at the edge, on-prem data center, cloud, etc., without the need for separate configuration and setup on individual machines.

With container orchestration platforms like Kubernetes, developers only have to worry about creating their containerized application, and Kubernetes automatically manage the entire application lifecycle. This includes automatic scheduling on a distributed cluster, execution of the containers, the automatic rollout of newer application versions and rollback, when needed.

In some instances, applications are written as a collection of microservices and deployed on platforms like Kubernetes, which then handle the execution of these microservices. Each microservice is isolated, and Kubernetes manages its execution independently. Whenever the demand increases, the microservice is scaled up and when the demand lowers, the microservice is automatically scaled down.

### SUMMARY

According to an aspect of the present invention, a computer implemented method is provided for content-aware auto-scaling of stream processing applications on container orchestration platforms. More particularly, a computer implemented method for content-aware auto-scaling of stream processing applications on container orchestration platforms is provided herein. In one embodiment, the method includes configuring an autoscaler in a control plane of the container orchestration platform to receive stream data from a data exchange system that is measuring stream processing of a pipeline of microservices. The method can further include controlling a number of deployment pods in at least one node of the container orchestration platform to improve application performance. For example, the number of deployment pods in at least one node of the container orchestration platform can be set to meet requirements for the application provided by the pipeline of microservices.

In accordance with another embodiment of the present disclosure, a system for scaling in a container orchestration platform is provided. In one embodiment, the system includes a hardware processor; and a memory that stores a computer program product. The computer program product when executed by the hardware processor, causes the hardware processor to configure an autoscaler in a control plane of the container orchestration platform to receive stream data from a data exchange system that is measuring stream processing of a pipeline of microservices. The computer program product of the system that is executed by the hardware processor can also control a number of deployment pods in at least one node of the container orchestration platform to improve application performance. For example, the number of deployment pods in at least one node of the container orchestration platform can be set to meet requirements for the application provided by the pipeline of microservices.

In accordance with yet another embodiment of the present disclosure a computer program product for scaling in a container orchestration platform. The computer program product can include a computer readable storage medium having computer readable program code embodied therewith. The program code executable by a processor to cause the processor to configure an autoscaler in a control plane of the container orchestration platform to receive stream data from a data exchange system that is measuring stream processing of a pipeline of microservices, and control a number of deployment pods in at least one node of the container orchestration platform to improve application performance. For example, the number of deployment pods in at least one node of the container orchestration platform can be set to meet requirements for the application provided by the pipeline of microservices.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 illustrates a Kubernetes cluster architecture, in accordance with one embodiment of the present disclosure.

FIG. 2 is an illustration of a general environment depicting a video analytics application pipeline for face recognition, which processes a stream of data, i.e., frames coming out from a video camera, in accordance with one embodiment of the present disclosure.

FIG. 3 is an illustration of the logical and physical views of an application pipeline, in accordance with one embodiment of the present disclosure.

FIG. 4 is a block/flow diagram of an exemplary method for container orchestration platform, in accordance with embodiments of the present invention.

FIG. 5 is a block/flow diagram providing further details for scaleout and downscaling operations for the method illustrated in FIG. 4.

FIG. 6 is a block/flow diagram of an exemplary processing system for scaling in a container orchestration platform, in accordance with embodiments of the present invention.

### DETAILED DESCRIPTION OF PREFERRED EMBODIMENTS

In accordance with embodiments of the present invention, systems and methods are provided for content-aware auto-scaling of stream processing application on container orchestration platforms. Kubernetes is one example of an open source container orchestration platform that can be used in cloud computing environments.

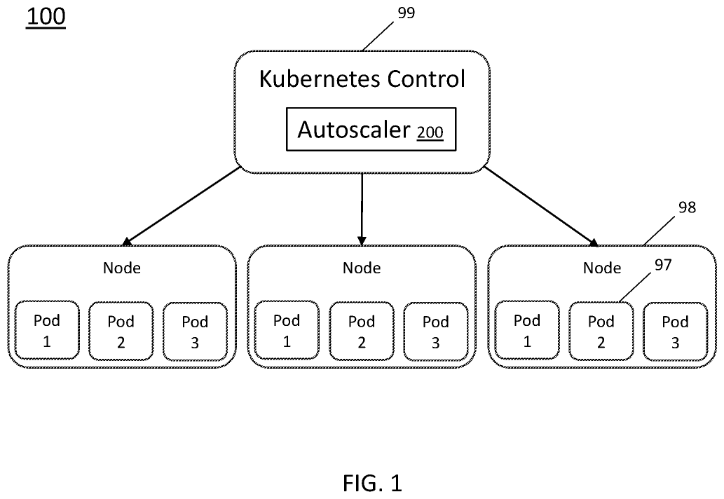

FIG. 1 illustrates a Kubernetes cluster architecture 100. Clusters 100 are how Kubernetes groups machines. A cluster 100 contains, at minimum, a control plane 99 and one or several nodes 98. The control plane 99 maintains the clusters' desired state, such as which applications run on them and which images they use. The control plane 99 also includes the scaling mechanisms, e.g., autoscaler 200.

The clusters 100 are comprised of nodes 98 (individual machines) which run pods 97 Pods have containers that request resources such as CPU, Memory, and GPU.

Applications can be built using microservice based architecture and are typically deployed on container orchestration platforms like Kubernetes. The default horizontal scaling technique in Kubernetes, i.e., Horizontal Pod Autoscalar (HPA), is effective when the application is stand-alone. However, it has been determined when the application consists of multiple inter-connected microservices, continuously talking to each other to process real-time data stream, then the scaling performed by HPA can be inefficient.

More specifically, there are two mechanisms for independent scaling in Kubernetes, i.e., Horizontal Pod Autoscaler (HPA) and Vertical Pod Autoscaler (VPA). HPA scales the microservice by configuring the number of replicas that are running. In contrast, VPA scales the microservice by changing the resources assigned to the microservice e.g., CPU, memory, etc. Such scaling using HPA or VPA is effective for independent scaling of microservices, where the interactions among the microservices are ignored for scaling purpose. However, it has been determined that when the microservices interact with each other in complex ways, the auto-scaling of such application pipelines in Kubernetes is inefficient.

The computer implemented methods, systems and computer program products that are described herein can provide optimal scaling for different microservices that can vary as the stream content changes. In some embodiments, to automatically adapt to variations in stream content, the computer implemented methods, systems and computer program products employ a microservice pipeline autoscaler 200, which leverages knowledge of the stream processing application pipeline in order to efficiently and dynamically scale different microservices. The microservice pipeline autoscaler 200 runs as a Kubernetes operator, e.g., in the control plane 99, and efficiently manages to scale the stream processing application pipelines on Kubernetes. The number of pods may be increased or decreased to meet the requirements for running the application in response to changes in user need, e.g., changing in computing budget.

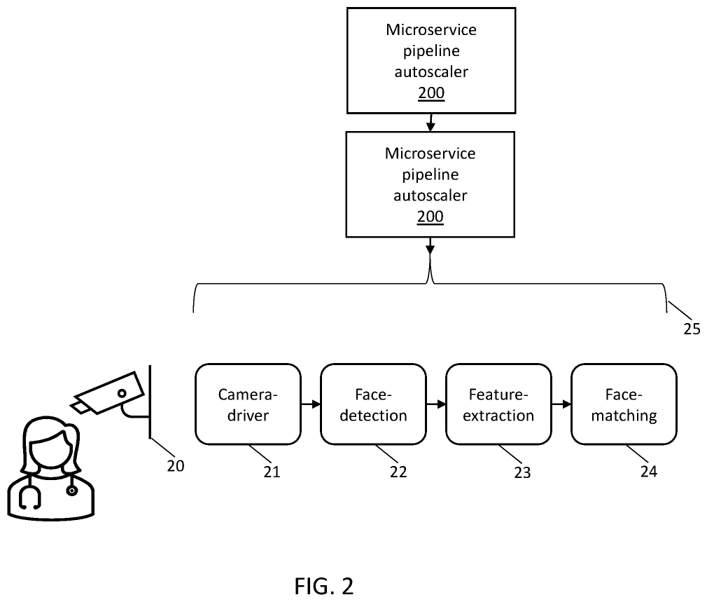

FIG. 2 shows a video analytics application pipeline for face recognition (FR), which processes a stream of data, i.e., frames coming out from a video camera 20. Here, the first microservice camera-driver 21, fetches the frames, decodes them, and makes them available to face-detection 22. Faces are detected in these frames by face-detection 22 and made available to feature extraction 23, which then extracts face features and makes these features available to face-matching 24. There is a pre-registered gallery of faces, along with the extracted features for these faces, which is used by face-matching to match features from feature-extraction against the features in the pre-registered gallery. If any of the features match with a high matching score, then a face is recognized and a face match event is emitted. This application is useful in various domains, including video surveillance, safety, and security, retail, banking, etc.

The different microservices, camera-driver 21, face-detection 22, feature-extraction 22 and face-matching 24, shown in FIG. 1 are chained together and continuously communicate with each other through a data system. The chain of the individual microservices is referred to as a pipeline 25. Depending on the video content, these components need to scale appropriately. This scaling can happen horizontally by creating multiple copies. Prior to the methods, systems and computer program products of the present disclosure, in Kubernetes, this type scaling is done on a per microservice basis, without taking into account the interaction between them. This leads to inefficient scaling and degrades the performance of the entire application.

Referring to FIG. 2, the microservice pipeline autoscaler 200 of the present disclosure does not require any scaling-related configuration parameters to be specified. Furthermore, the microservice pipeline autoscaler 200 can perform better scaling than HPA by balancing resources allocated to different microservices in the application pipeline such that there is minimal wastage of computing resources.

Referring to the example depicted in FIG. 2, unlike HPA, the design of the microservice pipeline autoscaler 200 considers the entire application pipeline 25 while making scaling decisions. While scaling microservices in Kubernetes using HPA, one has to specify the minimum and maximum replicas to be created, and also metrics like target CPU usage, which may be difficult to specify for each individual microservice. The microservice pipeline autoscaler 200 on the other hand relieves the administrator/maintainer from the burden of specifying any such scaling-related configuration parameters.

Also, with HPA, all replicas are created with same priorities. The microservice pipeline autoscaler 200 on the other hand introduces varying priorities during scaling, wherein higher priority instances can pre-empt lower priority ones in order to balance allocation of resources across different microservices in the application pipeline. Since HPA treats each microservice independently, it may perform inefficient scaling, e.g., more replicas may be created for the initial stages of the pipeline than later ones, when it would have been beneficial to create additional replicas for later stages than initial stages.

The microservice pipeline autoscaler 200 on the other hand balances scaling of instances across all stages, e.g., all microservices 21, 22, 23, 24 of the pipeline 25 in order to improve application performance.

The microservice pipeline autoscaler 200 is implemented as an operator running alongside DataX, which runs on top of Kubernetes. DataX is a platform that enables exchange, transformations, and fusion of data streams, and leverages serverless computing to transform, fuse, and auto-scale microservices. DataX is hereafter referred to as a data exchange system 201.

There are different entities registered through the data exchange systems 201, e.g., DataX. For example, entities that can be registered through the data exchange systems, may include drivers, analytic units (Aus), and actuators with corresponding sensors, streams, and gadgets, respectively. For a stream processing application topology, sensors fetch raw sensor data, which are consumed by one or more streams to generate augmented streams, which are further consumed by one or more streams, and finally, the pipeline is terminated at the last streams or gadgets, which control one or more physical actuating devices. This entire stream processing application topology is exposed through data exchange system, e.g., DataX, and the microservice pipeline autoscaler 200 leverages this to efficiently scale the entire stream processing application pipeline on Kubernetes.

Referring to FIG. 2, the autoscaling strategy used by the microservice pipeline autoscaler 200 does not employ “replicaset” for creating multiple replicas. The microservice pipeline autoscaler 200 creates separate “Deployment” instances (pods) with varying priorities. Scaling in the microservice pipeline autoscaler 200 happens only for analytic units (Aus) which are stateless i.e. there is no state maintained in them. Each stateless analytic units AU(sAU) has its own “Deployment”. The “Deployment” for the analytic units (Aus) are defined as following for each stateless analytic unit (sAU):
Desired instances: This is the total number of desired instances of the stateless analytic units (SAU).
Scheduled instances: This is the total number of scheduled instances of the sAU i.c. those that are created and added in Kubernetes' queue for execution.
Running instances: This is the total number of running instances of the sAU i.e. those that are already running on some node within the Kubernetes cluster.

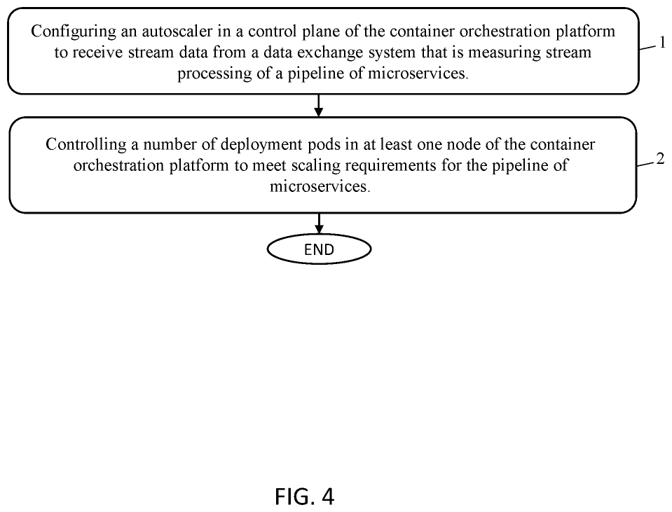

FIG. 4 is illustrative of an exemplary method for scaling in a container orchestration platform, in accordance with embodiments of the present invention. Block 1 illustrates configuring an autoscaler in a control plane of the container orchestration platform to receive stream data from a data exchange system that is measuring stream processing of a pipeline of microservices. Block 2 of the method includes controlling a number of deployment pods in at least one node of the container orchestration platform to improve application performance.

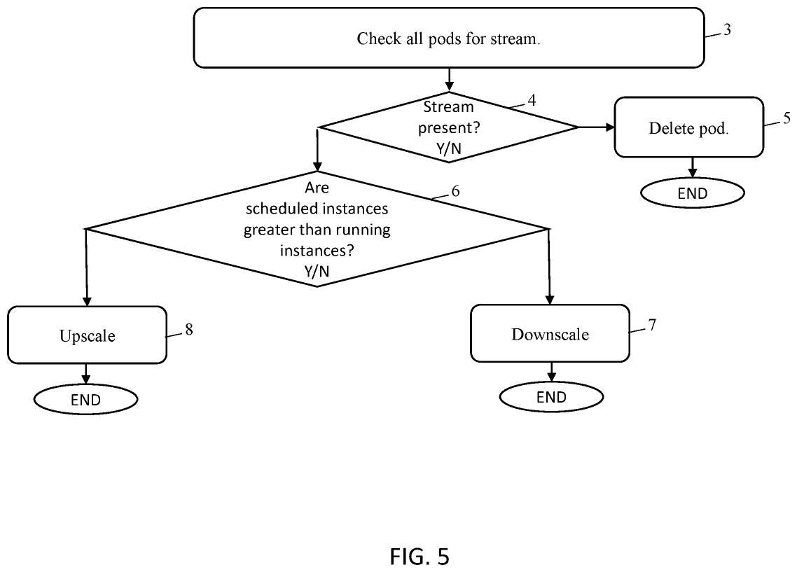

FIG. 5 is a diagram providing further details for scaleout and downscaling operations for the method illustrated in FIG. 4. Block 3 includes the microservice pipeline autoscaler 200 checking the pods for stream performance. If a stream is not detected at block 4, the method can continue to deleting that pod at block 5. If a stream is detected at block 4, the method continues to block 6 with determining whether to scale out at block 7 or downscale at block 8. For example, a determination is made at block 6 as to whether scheduled instances for the pods are greater than the running instances. If the scheduled instances are greater, the method advancing with scale out the development pods at block 8. If the scheduled instances are not greater, the method advancing with downscaling the development pods at block 87.

The main loop for microservice pipeline autoscaler 200 shown in Algorithm 1, as follows:

Algorithm 1 AutoScaler Scale Up/Down (main) loop

| Input: Stateless AUs | |
|---|---|
| Output: Scaling decision and execution | |
| 1: | while true do |
| 2: | scaleDownRequired ← false |
| 3: | for sAU ∈ stateless AUs do |
| 4: | if isUsed (sAU) then |
| 5: | if scheduled(sAU) > running(sAU) then |
| 6: | scaleDownRequired ← true |
| 7: | end if |
| 8: | if desired(sAU) > scheduled(sAU) then |
| 9: | ScaleOut (sAU) |
| 10: | end if |
| 11: | else |
| 12: | delete(sAU) |
| 13: | end if |
| 14: | end for |
| 15: | if scaleDownRequired then |
| 16: | ScaleDown( ) |
| 17: | end if |
| 18: | sleep(interval) |
| 19: | end while |

The loop is repeated at periodic intervals, e.g., every few minutes and during every cycle, the microservice pipeline autoscaler 200 goes through all stateless analytics unit (Aus), e.g., at block 3 of FIG. 4. For each stateless analytics unit AU (sAU), if it is being used, i.e., if there is any stream declared to be generated using sAU, then microservice pipeline autoscaler 200 checks if scale down or scaleout is required for sAU, e.g., at block 6 of FIG. 5. If sAU is not used, then all instances of sAU are deleted by microservice pipeline autoscaler 200, e.g., at block 5 of FIG. 5. For scaling decision, if scheduled instances of sAU are more than the running instances, then scale down of some other AU instances is required so that the scheduled instances of sAU can run, e.g., by descale at block 7 in FIG. 5. On the other hand, if the desired instances of stateless analytic units (sAU) are more than the scheduled instances of sAU, then a scale out is required for stateless analytic units (sAU), i.e., more number of instances need to be created for stateless analytic units (sAU), e.g., by scale out at block 8 in FIG. 5.

The strategy used and the procedure followed by microservice pipeline autoscaler 200 for scaling out is shown in Algorithm 2, as follows:

Algorithm 2 AutoScaler ScaleOut (sAU)

| Input: Stateless AU to scale out (sAU) | |
|---|---|
| Output: Execution of scaling out for sAU | |
| 1: | deployment ← GetKubernetesDeployment (sAU) |
| 2: | Pₒ ← 100 × (1 − (running(sAU)/desired(sAU))) |
| 3: | gap ← desired(sAU) − scheduled (sAU) |
| 4: | for i ∈ range(0, (gap − 1)) do |
| 5: | priority ← ceil (Pₒ − (i × (Pₒ/gap))) |
| 6: | CreateKubernetesPod(deployment, priority) |
| 7: | end for |

In some embodiments, the first step for scaling out is fetching the corresponding “Deployment” from Kubernetes for the sAU. After this, a constant Pₒ is initialized with the formula shown in line 2 in Algorithm 2. The gap between the desired and scheduled instances of sAU is identified and then those many number of instances (pods) of sAU are created. While creating the pods, microservice pipeline autoscaler 200 assigns a priority to the pod, which is calculated by the formula given in line 6 in Algorithm 2. These priorities aid microservice pipeline autoscaler 200 in intelligently pre-empting lower priority pods and balancing scaling and execution of the entire stream processing application pipeline.

Algorithm 3 shows the procedure followed by microservice pipeline autoscaler 200 to scale down instances of stateless analytic units (Aus).

Algorithm 3 AutoScaler ScaleDown (sAU)

| Input: Stateless AU with no scaling down (sAU) | |
|---|---|
| Output: Execution of scaling down for other AUs | |
| 1: | for s ∈ statelessAUs do |
| 2: | gap ← scheduled(s) − desired(s) |
| 3: | if gap > 0 then |
| 4: | pods ← GetKubernetesPods (s) |
| 5: | SortByPriority (pods) |
| 6: | Scale down s by gap instances |
| 7: | for i ∈ range(0, (gap − 1)) do |
| 8: | DeleteKubernetesPod(pods [i]) |
| 9: | end for |
| 10: | end if |
| 11: | end for |

In some embodiments, a desired instances calculation strategy is employed to by the microservice pipeline autoscaler 200 to calculate the desired number of instances for any specific stateless pod AU(sAU).

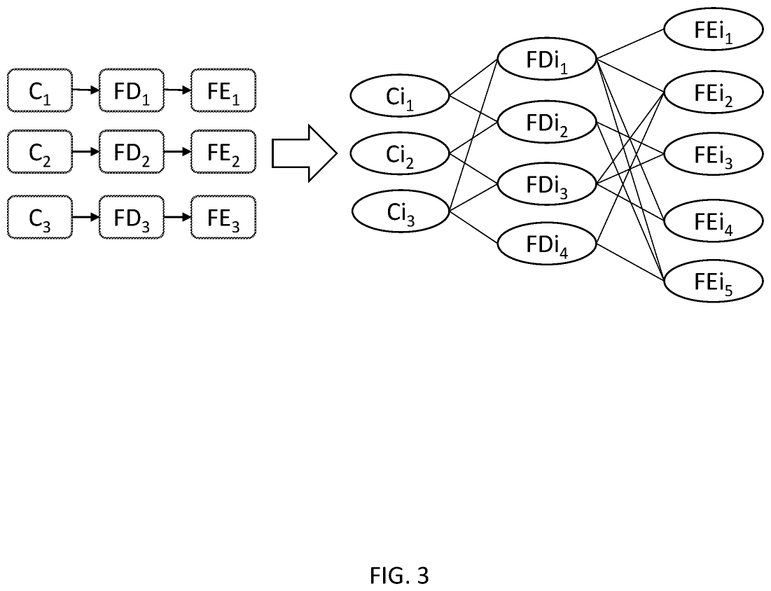

FIG. 3 shows a logical and physical view of facial recognition (FR) application pipeline for 3 cameras. As shown in FIG. 3, different number of instances of FD (face-detection) and FE (feature-extraction) will be required depending on the video content and appropriate number of desired instances of FD and FE will have to be created by microservice pipeline autoscaler 200 dynamically.

Some of the terms used by microservice pipeline autoscaler 200 to calculate the desired number of instances are discussed below:

Input Rate (IR): Input rate indicates the rate of input received by the stateless analytic units (AU.) Stateless AU can receive inputs from several streams. IR is the sum of the Production Rate (PR) or MSG/s from each input stream s. In FIG. 3, IR for FD is the sum of the PR of C₁, C₂ and C₃. In general, input rate is defined in Equation (1) as follows:

$$IR ( sAU ) = {\sum }_{s}^{input \_ streams} PR ( s ) \qquad ( 1 )$$

Output Rate (OR): Output rate indicates the rate of consumption of the messages produced by the stateless pods (AU). OR for FD is the sum of the maximum consumption rate (CR) of the subscribers of each stream serviced by the stateless AU.

In FIG. 3, OR for FD is the sum of the consumption rate (CR) of all the subscribers of all the FD streams (FE).

Stateless AU can have multiple output streams. Messages from an output stream s are distributed to multiple subscribers, and Consumption Rate (CR) is the MSG/s received by a subscriber b of stream s. OR is equation (2), as follows:

$$OR ( sAU ) = {\sum }_{s}^{output \_ streams} {max}_{b} cR ( b ) \qquad ( 2 )$$

Subscriber Processing Time (SPT): Subscriber processing time indicates how much time the subscribers of each stream serviced by the stateless AU spend processing input (rather than waiting for it). This is the time spent in processing input as the processing time (PT) of the subscriber stream, and this is a number between 0 and 1. In FIG. 3, SPT for FD is the average time spent in processing by the subscriber streams (SS) of FD, which are the instances of Feature Extraction i.e. FEi₁, FEi₂, FEi₃, FEi₄ and FEi₅. SPT is defined as in Equation 3, as follows:

$$SPT ( sAU ) = \frac{1}{SS} {\sum }_{s}^{SS} PT ( s ) \qquad ( 3 )$$

Target Processing Rate (TPR): Target processing rate indicates the optimal processing rate for the stateless AU. If the stateless AU is at the last stage of the pipeline, then the target processing rate is the same as the input rate; in other words, it should process all of its input. If the stateless AU is in the middle of the pipeline, its target processing rate should be high enough to keep the subscribers busy processing rather than waiting for the input. This means the target processing rate is set as the current output rate incremented by the fraction of time that the subscribers are just waiting for input. If such a value is higher than the input rate, then we set the target processing rate the same as the input rate. TPR is defined as in Equation 4, as follows.

$$TPR ( sAU ) = \{ \begin{matrix}IR ( sAU ) , & last stage \\ min ( IR ( sAU ) , ( 2 - SPT ( sAU ) ) \cdot OR ( sAU ) ) , & otherwise\end{matrix} \qquad ( 4 )$$

Desired Instances (DI) calculation: Desired instances indicate the number of desired instances for the stateless AU to be able to deliver the target processing rate. In general, we assume that the current processing rate (CPR) is proportional to the current number of running instances (RI) of the stateless AU scaled by the average percentage of time spent in processing the input (given by MPT (mean processing time) in Equation 5). Hence, we can compute the number of instances required to achieve the target processing rate using the formula in Equation 5:

$$DI ( sAU ) = ceil ( \frac{RI ( sAU ) \cdot MPT ( sAU ) \cdot TPR ( sAU )}{CPR ( sAU )} ) \qquad ( 5 )$$

In this manner, DataX AutoScaler calculates the desired number instances for any specific AU and repeats Algorithm 1 periodically in order to make efficient scaling decisions for the entire stream processing application pipeline.

For example, in the facial recognition(FR) application pipeline, shown in FIG. 2, to evaluate the overall application performance, the performance metric messages/second (MSG/s) is defined. Messages/second (MSG/s) is the average number of messages produced per second by the copies of the final microservice in the application pipeline. Higher number of messages per second in this final stage indicates that the entire application pipeline is able to process more input data, which typically helps improve analytics accuracy. The computer implemented methods, systems and computer program products can reduce compute processing by up to 40% using the microservice pipeline autoscaler 200 when compared to similar autoscaling using HPA or VPA.

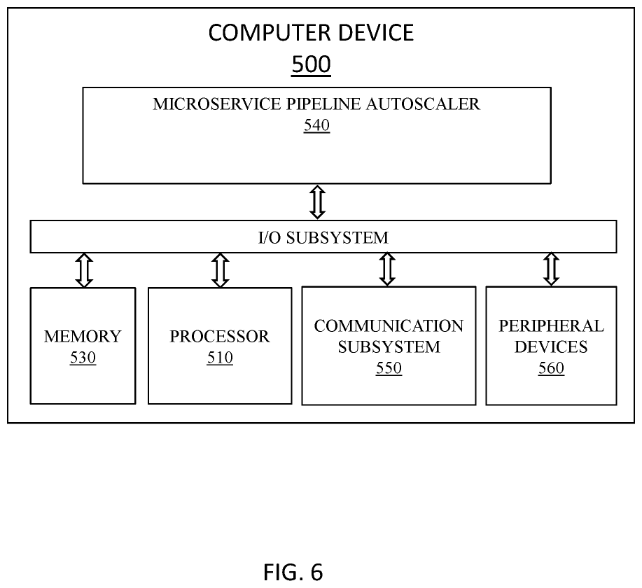

Referring now to FIG. 6, an exemplary computing device 500 is shown, in accordance with an embodiment of the present invention. The computing device 500 can be configured to perform scaling in a container orchestration platform. For example, the system may include a hardware processor 510; and a memory 530 that stores a computer program product. The memory 530 may include data storage 540. The computing device 500 can include a computer program product in the data storage 540 that can include computer readable program code embodied therewith, the program instructions executable by a processor to cause the processor to configure an autoscaler 200 in a control plane 99 of the container orchestration platform to receive stream data from a data exchange system that is measuring stream processing of a pipeline of microservices 25; and control a number of deployment pods 97 in at least one node 98 of the container orchestration platform to application performance Further details for controlling the number of deployment pods 97 are described above with reference to FIGS. 4 and 5.

Referring back to FIG. 6, the computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 6, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code for the entity extractor 541, the knowledge graph expansion generator 542, and the knowledge predictor 543.

Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. For example, a computer program product may be provided for scaling in a container orchestration platform. The computer program product may a computer readable storage medium having computer readable program code embodied therewith, the program instructions executable by a processor to cause the processor to configure an autoscaler in a control plane of the container orchestration platform to receive stream data from a data exchange system that is measuring stream processing of a pipeline of microservices. The program instructions can also cause the processor control a number of deployment pods in at least one node of the container orchestration platform to meet scaling requirements for the pipeline of microservices.

A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method of scaling in a container orchestration platform comprising:
configuring an autoscaler in a control plane of the container orchestration platform to receive stream data from a data exchange system that is measuring stream processing of a pipeline of microservices for an application; and
controlling a number of deployment pods in at least one node of the container orchestration platform to meet requirements for the application provided by the pipeline of microservices.

2. The computer implemented method of claim 1, wherein controlling the number of deployment pods comprises scale out.

3. The computer implemented method of claim 2, wherein upscaling occurs when the autoscaler determines from the stream processing of the pipeline of microservices that desired instances of the deployment pods are less than scheduled instances of the deployment pods.

4. The computer implemented method of claim 1, wherein controlling the number of deployment pods comprises downscaling.

5. The computer implemented method of claim 4, wherein downscaling occurs when the autoscaler determines from the stream processing of the pipeline of microservices that desired instances of the deployment pods are more than scheduled instances of the deployment pods.

6. The computer implemented method of claim 1, wherein the container orchestration platform is Kubernetes.

7. The computer implemented method of claim 1, wherein the pipeline of microservices is employed for facial recognition.

8. A system for scaling in a container orchestration platform comprising:
a hardware processor; and
a memory that stores a computer program product, the computer program product when executed by the hardware processor, causes the hardware processor to:
configure, using the hardware processor, an autoscaler in a control plane of the container orchestration platform to receive stream data from a data exchange system that is measuring stream processing of a pipeline of microservices for an application; and
control, using the hardware processor, a number of deployment pods in at least one node of the container orchestration platform to meet requirements for the application provided by the pipeline of microservices.

9. The system of claim 8, wherein controlling the number of deployment pods comprises scale out.

10. The system of claim 9, wherein upscaling occurs when the autoscaler determines from the stream processing of the pipeline of microservices that desired instances of the deployment pods are less than scheduled instances of the deployment pods.

11. The system of claim 8, wherein controlling the number of deployment pods comprises downscaling.

12. The system of claim 11, wherein downscaling occurs when the autoscaler determines from the stream processing of the pipeline of microservices that desired instances of the deployment pods are more than scheduled instances of the deployment pods.

13. The system of claim 8, wherein the container orchestration platform is Kubernetes.

14. The system of claim 8, wherein the pipeline of microservices is employed for facial recognition.

15. A computer program product for scaling in a container orchestration platform, the computer program product can include a computer readable storage medium having computer readable program code embodied therewith, the program instructions executable by a processor to cause the processor to:
configure an autoscaler in a control plane of the container orchestration platform to receive stream data from a data exchange system that is measuring stream processing of a pipeline of microservices for an application; and
control a number of deployment pods in at least one node of the container orchestration platform to meet requirements for the application provided by the pipeline of microservices.

16. The computer program product of claim 15, wherein controlling the number of deployment pods comprises scaling out.

17. The computer program product of claim 16, wherein upscaling occurs when the autoscaler determines from the stream processing of the pipeline of microservices that desired instances of the deployment pods are less than scheduled instances of the deployment pods.

18. The computer program product of claim 15, wherein controlling the number of deployment pods comprises downscaling.

19. The computer program product of claim 18, wherein downscaling occurs when the autoscaler determines from the stream processing of the pipeline of microservices that desired instances of the deployment pods are more than scheduled instances of the deployment pods.

20. The computer program product of claim 15, wherein the container orchestration platform is Kubernetes.
